(19) United States
(12) Patent Application Publication
(10) Pub. No.: US 2006/0251167 A1
(43) Pub. Date: Nov. 9, 2006

(54) Multi-track hinting for receiver-driven streaming system

(75) Inventors: Mihaela Van Der Schaar, Martinez, CA (US); Qiong Li, Tappan, NY (US)

Correspondence Address: PHILIPS INTELLECTUAL PROPERTY & STANDARDS, P.O. BOX 3001, BRIARCLIFF MANOR, NY, 10510, US

(73) Assignee: koninkijkle phillips electronics n.v.

(21) Appl. No.: 10/539,698

(22) PCT Filed: Dec. 16, 2003
(86) PCT No.: PCT/IB03/06004

§ 371 Date: Jun. 16, 2005

Related U.S. Application Data
(60) Provisional application No. 60/435,242, filed on Dec. 20, 2002.

(51) Int. Cl. H04N 7/12

(52) U.S. Cl. 375/240.02

(57) ABSTRACT

A receiver-driven streaming method is provided. The method includes receiving an original coded video stream from a transmitter 102 at a receiver 104. An available bit rate is measured at the receiver 104. A request for a different coded video stream and a switching stream is sent from the receiver 104 to the transmitter 102 based on the available bit rate. The requested switching stream is received from the transmitter 102 at the receiver 104. The requested coded video stream is received from the transmitter 102 at the receiver 104.

According to one embodiment, switching streams 132a-132f are stored separately from coded video streams 130a-130c, and each switching stream 132a-132f and coded video stream 130a-130c is stored in a separate track from each other. In this way, switching streams 132a-132f maybe generated offline. Also, the receiver 104 controls the streams provided by the transmitter 102 by requesting specific switching streams 132a-132f and coded video streams 130a-103c.

### TECHNICAL FIELD OF THE INVENTION

The present invention relates generally to multi-track hinting and streaming systems and, more particularly, to a multi-track hinting for receiver-driven streaming system for non-scalable video coding using switching frames and method.

### BACKGROUND OF THE INVENTION

With the rapid development of broadband Internet technologies, video streaming is envisioned to become the dominant Internet application in the near future. Similarly, the falling cost of wireless local area network (WLAN) products has led to their increased use in consumer homes. Also, although currently most WLANs are predominantly used for data transfer, the higher bandwidth provided by new WLAN technologies, such as IEEE 802.11a and IEEE 802.11g, may ultimately lead to their increasing use for video transmission. Furthermore, future wireless video applications will have to work over an open, layered, Internet-style network with a wired backbone and wireless extensions. Therefore, common protocols will have to be used for transmission across both the wired and wireless portions of the network. These protocols will most likely be future extensions of the existing protocols that are based on the Internet Protocol (IP).

Consequently, due to the inherent resource sharing nature of the Internet and wireless networks, multimedia communications of the future will mainly use variable bandwidth channels. Hence, if streaming of video content is performed over this type of network, the instantaneous data rate must frequently be tailored to fit the available resources. This can be achieved in a very flexible way by the approach of scalable coding. Scalable video-coding schemes are able to provide a simple and flexible framework for transmission over heterogeneous networks.

However, in order to provide the required adaptation to bandwidth variations, device characteristics and user requirements, multiple non-scalable video coding with a different data rate needs to be transmitted using an appropriate streaming architecture. The MPEG-4 Systems Group has developed and standardized the streaming strategy for non-scalable coded video over IP networks. However, this strategy is unable to efficiently adapt to channel conditions, complexity constraints and user preferences. In addition, conventional systems such as these require the transmitter to be responsible for inserting the correct switching frames into the video stream to accomplish smooth switching.

### SUMMARY OF THE INVENTION

In accordance with the present invention, a multi-track hinting for receiver-driven streaming system for non-scalable video coding using switching frames and method are provided that substantially eliminate or reduce disadvantages and problems associated with conventional systems and methods. In particular, each receiver may independently adapt its received video optimally to its own perceived network conditions.

According to one embodiment of the present invention, a receiver-driven streaming method is provided. The method includes receiving an original coded video stream from a transmitter at a receiver. An available bit rate is measured at the receiver. A request for a different coded video stream and a switching stream is sent from the receiver to the transmitter based on the available bit rate. The requested switching stream is received from the transmitter at the receiver. The requested coded video stream is received from the transmitter at the receiver.

According to another embodiment of the present invention, a receiver-driven streaming method is provided that includes transmitting an original coded video stream from a transmitter to a receiver. A request for a different coded video stream and a switching stream is received from the receiver at the transmitter. The requested switching stream is transmitted from the transmitter to the receiver. The requested coded video stream is transmitted from the transmitter to the receiver.

Technical advantages of one or more embodiments of the present invention include providing an improved streaming system. In a particular embodiment, coded video streams at different bit rates and switching streams are stored in separate tracks. In this way, a receiver-driven streaming system is provided that may respond more quickly to network changes than a transmitter-driven streaming system, thereby achieving better performance. This is due to the ability of each receiver to independently adapt its received video optimally to its own perceived network conditions.

Other technical advantages will be readily apparent to one skilled in the art from the following figures, description, and claims.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention and its advantages, reference is now made to the following description taken in conjunction with the accompanying drawings, wherein like reference numerals represent like parts, in which:

FIG. 1 is a block diagram illustrating a receiver-driven streaming system in accordance with one embodiment of the present invention;

FIGS. 2A-B are block diagrams illustrating a multi-track hinting file format in accordance with one embodiment of the present invention;

FIG. 3 is a flow diagram illustrating a receiver-driven streaming method from the perspective of the transmitter of FIG. 1 in accordance with one embodiment of the present invention; and

FIG. 4 is a flow diagram illustrating a receiver-driven streaming method from the perspective of one of the receivers of FIG. 1 in accordance with one embodiment of the present invention.

### DETAILED DESCRIPTION OF THE INVENTION

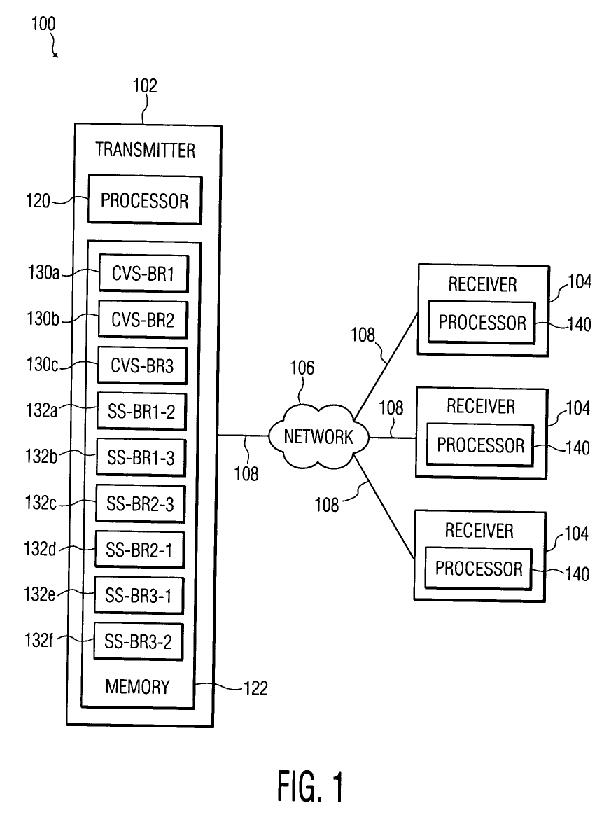

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged streaming system.

FIG. 1 is a block diagram illustrating a receiver-driven streaming system 100 in accordance with one embodiment of the present invention. The system 100 comprises a transmitter 102, at least one receiver 104 and a network 106 for providing communication between the transmitter 102 and the receivers 104. It will be understood that the system 100 may comprise any other suitable components of a streaming system, such as other suitable servers coupled to the network 106, without departing from the scope of the present invention.

The transmitter 102 comprises a processor 120 and a memory 122. The processor 120 is operable to code video streams at different bit rates, store the coded video streams in separate tracks in the memory 122, generate switching streams for the coded video streams, and store the switching streams in separate tracks in the memory 122. The transmitter 102 is also operable to generate and store a hinting track (not illustrated in FIG. 1) for each coded video stream and switching stream. The processor 120 is also operable to transmit the coded video streams and the switching streams to the receivers 104 through the network 106.

The memory 122 may comprise random access memory (RAM), a combination of RAM and read only memory (ROM), or any other suitable form of memory. According to one embodiment, the memory 122 may comprise a non-volatile RAM, such as flash memory. The memory 122 is operable to store a plurality of coded video streams 130 and a plurality of switching streams 132.

For the illustrated embodiment, the memory 122 stores three coded video streams 130: one coded video stream 130a at a first bit rate (CVS-BR1), one coded video stream 130b at a second bit rate (CVS-BR2), and one coded video stream 130c at a third bit rate (CVS-BR3). In addition, the illustrated memory 122 stores six switching streams 132, one for each of the possible bit rate changes between the three bit rates for the three coded video streams 130. However, it will be understood that the memory 122 may store any suitable number of coded video streams 130 and switching streams 132 without departing from the scope of the present invention.

For example, even for an embodiment in which the memory 122 stores three coded video streams 130, the memory 122 may store only four switching streams 132a,c,d,f. For this embodiment, coded video streams 130 may only be changed to an adjacent coded video stream 130, instead of allowing the coded video stream 130a to be changed directly to the coded video stream 130c, for example. Thus, the coded video stream 130a would first be changed to the coded video stream 130b and then changed to the coded video stream 130c.

Each receiver 104 comprises a processor 140 that is operable to receive a coded video stream 130 from the transmitter 102 through the network 106, to measure the available bit rate for the receiver 104 from the network 106, and to request a switching stream 132 and a different coded video stream 130 from the transmitter 102 based on the available bit rate. Thus, each receiver 104 may independently optimize its video stream being provided by the transmitter 102 based on the network conditions for that receiver 104. As used herein, “each” means every one of at least a subset of the identified items.

In one embodiment, the network 106 comprises a packet data network, such as the Internet, or other suitable network. However, the network 106 may also comprise any interconnection found on any computer network such as a local area network (LAN), a wide area network (WAN), or any other communications and data exchange systems created by connecting two or more computers.

The transmitter 102 and the receivers 104 are operable to communicate with the network 106 over communication lines 108, which may be any type of communication link capable of supporting data transfer. In one embodiment, the communication lines 108 may comprise, alone or in combination, Integrated Services Digital Network (ISDN), Asymmetric Digital Subscriber Line (ADSL), T1 or T3 communication lines, hardwire lines, or telephone links. It will be understood that the communication lines 108 may comprise other suitable types of data communication links. The communication lines 108 may also connect to a plurality of intermediate servers between the network 106 and the transmitter 102 and the receivers 104.

At least a portion of the transmitter 102 and/or the receiver 104 may comprise logic encoded in media. The logic comprises functional instructions for carrying out program tasks. The media comprises computer disks or other computer-readable media, application-specific integrated circuits, field-programmable gate arrays, digital signal processors, other suitable specific or general purpose processors, transmission media or other suitable media in which logic may be encoded and utilized.

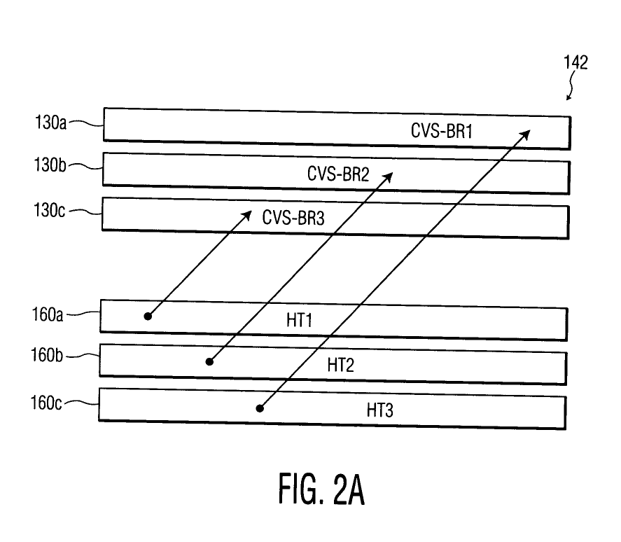

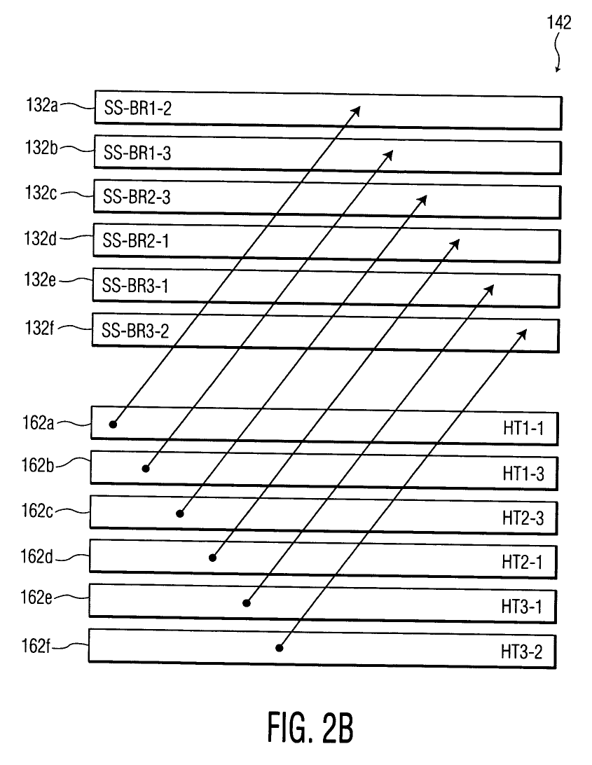

FIGS. 2A-B are block diagrams illustrating a multi-track hinting file format 142 in accordance with one embodiment of the present invention. For description purposes, FIG. 2A illustrates the file format 142 with respect to the coded video streams 130, while FIG. 2B illustrates the file format 142 with respect to the switching streams 132. However, it will be understood that the file format 142 comprises the combination of the two illustrations.

The illustrated embodiment of the file format 142 corresponds to the embodiment in which the transmitter 102 stores three coded video streams 130 and six switching streams 132. Thus, it will be understood that the file format 142 may be altered so as to accommodate different numbers of coded video streams 130 and/or switching streams 132.

In addition to the three coded video streams 130, the file format 142 of FIG. 2A comprises three hinting tracks 160. As indicated by the arrows, each hinting track 160 corresponds to one of the coded video streams 130.

Similarly, in addition to the six switching streams 132, the file format 142 of FIG. 2B comprises six hinting tracks 162. As indicated by the arrows, each hinting track 162 corresponds to one of the switching streams 132. Thus, the combined file format 142 provides a separate hinting track 160, 162 for each of these streams 130, 132.

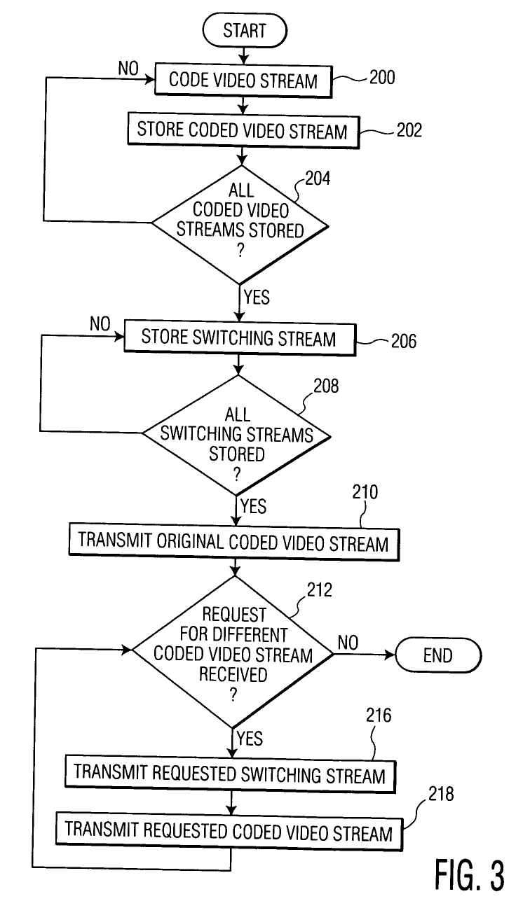

FIG. 3 is a flow diagram illustrating a receiver-driven streaming method from the perspective of the transmitter 102 in accordance with one embodiment of the present invention. The method begins at step 200 where the transmitter 102 codes a video stream for transmission to the receiver 104. At step 202, the transmitter 102 stores the coded video stream 130 in the memory 122 and also stores the hinting track for the coded video stream 130.

At decisional step 204, a determination is made regarding whether or not all coded video streams 130 at all desired bit rates have been stored in the memory 122. If the video stream has not been coded and stored at all the desired bit rates, the method follows the No branch from decisional step 204 and returns to step 200 where the transmitter 102 codes the video stream at another bit rate and then to step 202 where the transmitter 102 stores the coded video stream 130 in a separate track from any other coded video stream 130 and also stores the hinting track for the coded video stream 130.

However, if the video stream has been coded and stored in separate tracks at all the desired bit rates, the method follows the Yes branch from decisional step 204 to step 206. At step 206, the transmitter 102 stores a switching stream 132 for switching between coded video streams 130 in the memory 122 and also stores the hinting track for the switching stream 132.

At decisional step 208, a determination is made regarding whether or not all desired switching streams 132 have been stored in the memory 122. If all the desired switching streams have not been stored, the method follows the No branch from decisional step 208 and returns to step 206 where the transmitter 102 stores another switching stream 132 for switching between additional coded video streams 130 in a separate track from any other switching stream 132 in the memory 122 and also stores the hinting track for the switching stream 132.

However, if all the desired switching streams have been stored in separate tracks, the method follows the Yes branch from decisional step 208 to step 210. At step 210, the transmitter 102 transmits an original coded video stream 130 to the receiver 104. In addition, the transmitter 102 transmits to the receiver 104 data to inform the receiver 104 of the different bit rates corresponding to the stored coded video streams 130.

At decisional step 212, a determination is made regarding whether or not a request for a different coded video stream 130 has been received from the receiver 104. In addition to the different coded video stream 130, the request comprises a request for the switching stream 132 that corresponds to the difference between the original coded video stream 130 and the requested coded video stream 130. If no such request is received, the method follows the No branch from decisional step 212 and comes to an end. However, if such a request is received, the method follows the Yes branch from decisional step 212 to step 214.

At step 216, the transmitter 102 transmits the requested switching stream 132 to the receiver 104. At step 218, the transmitter 102 transmits the requested coded video stream 130 to the receiver 104, at which point the method returns to decisional step 212 to determine whether or not an additional request for another coded video stream 130 has been received.

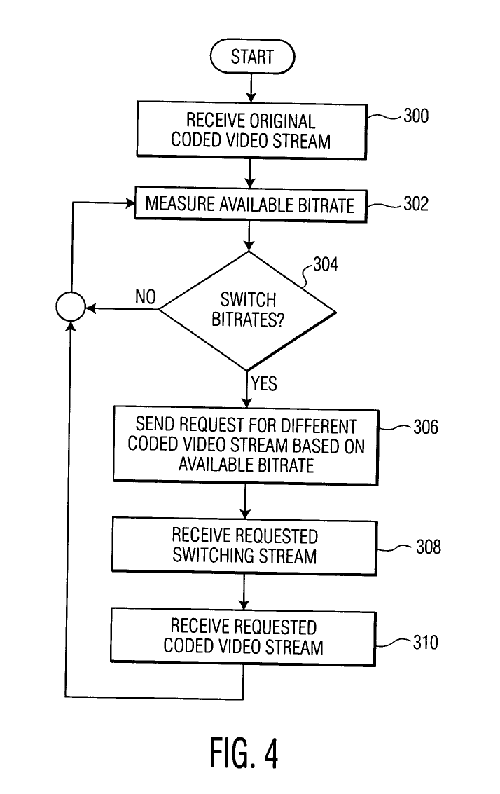

FIG. 4 is a flow diagram illustrating a receiver-driven streaming method from the perspective of the receiver 104 in accordance with one embodiment of the present invention. The method begins at step 300 where the receiver 104 receives the original coded video stream 130 from the transmitter 102. In addition, the receiver 104 receives data that informs the receiver 104 of the different bit rates corresponding to the the coded video streams 130 stored in the transmitter 104. At step 302, the receiver 104 measures the available bit rate for the receiver 104 from the network 106.

At decisional step 304, a determination is made regarding whether or not the receiver 104 should request a switch in bit rates for the coded video stream 130 based on the available bit rate. If the receiver 104 decides not to request a switch in bit rates, the method follows the No branch from decisional step 304 and returns to step 302 where the available bit rate continues to be measured. However, if the receiver 104 decides to request a switch in bit rates, the method follows the Yes branch from decisional step 304 to step 306.

At step 306, the receiver 104 sends a request for a different coded video stream 130 to the transmitter 102, with the requested coded video stream 130 based on the available bit rate. In addition to the different coded video stream 130, the request comprises a request for the switching stream 132 that corresponds to the difference between the original coded video stream 130 and the requested coded video stream 130. At step 308, the receiver 104 receives the requested switching stream 132 from the transmitter 102. At step 310, the receiver 104 receives the requested coded video stream 130, after which the method returns to step 302 where the available bit rate continues to be measured.

Although the present invention has been described with several embodiments, various changes and modifications may be suggested to one skilled in the art. It is intended that the present invention encompass such changes and modifications as fall within the scope of the appended claims.

1. A receiver-driven streaming method, comprising:
receiving an original coded video stream from a transmitter at a receiver;
measuring an available bit rate at the receiver;
sending a request for a different coded video stream and a switching stream based on the available bit rate from the receiver to the transmitter;
receiving the requested switching stream from the transmitter at the receiver; and
receiving the requested coded video stream from the transmitter at the receiver.

2. The method of claim 1, the receiver and the transmitter coupled to each other through a network.

3. The method of claim 1, the transmitter operable to store at least three coded video streams and at least four switching streams for each of a plurality of video streams.

4. The method of claim 1, the transmitter operable to store at least three coded video streams and at least six switching streams for each of a plurality of video streams.

5. A receiver-driven streaming method, comprising:
transmitting an original coded video stream from a transmitter to a receiver;
receiving a request for a different coded video stream and a switching stream from the receiver at the transmitter;
transmitting the requested switching stream from the transmitter to the receiver; and
transmitting the requested coded video stream from the transmitter to the receiver.

6. The method of claim 5, further comprising:
coding a plurality of video streams at a plurality of bit rates at the transmitter; and
storing each of the coded video streams in a separate track at the transmitter.

7. The method of claim 6, further comprising transmitting from the transmitter to the receiver data to inform the receiver of the plurality of bit rates corresponding to the stored coded video streams.

8. The method of claim 5, further comprising storing each of a plurality of switching streams in a separate track at the transmitter.

9. The method of claim 5, further comprising storing in separate tracks at the transmitter at least three coded video streams and at least four switching streams for each of a plurality of video streams.

10. The method of claim 5, further comprising storing in separate tracks at the transmitter at least three coded video streams and at least six switching streams for each of a plurality of video streams.

11. A receiver-driven streaming system, comprising:
a computer-processable medium; and
logic stored on the computer-processable medium, the logic operable to receive an original coded video stream, to measure an available bit rate, to send a request for a different coded video stream and a switching stream based on the available bit rate, to receive the requested switching stream, and to receive the requested coded video stream.

12. A receiver-driven streaming system, comprising:
a computer-processable medium; and
logic stored on the computer-processable medium, the logic operable to transmit an original coded video stream, to receive a request for a different coded video stream and a switching stream, to transmit the requested switching stream, and to transmit the requested coded video stream.

13. The system of claim 12, the logic further operable to code a plurality of video streams at a plurality of bit rates and to store each of the coded video streams in a separate track and to transmit data to inform a receiver of the plurality of bit rates corresponding to the stored coded video streams.

14. The system of claim 12, the logic further operable to store each of a plurality of switching streams in a separate track.

15. The system of claim 12, the logic further operable to store in separate tracks at least three coded video streams and at least four switching streams for each of a plurality of video streams.

16. The system of claim 12, the logic further operable to store in separate tracks at least three coded video streams and at least six switching streams for each of a plurality of video streams.

17. A receiver-driven video stream, comprising:
an original coded video stream;
a different coded video stream and a switching stream requested by a receiver measuring an available bit rate at the receiver and sending a request for the different coded video stream and the switching stream based on the available bit rate.

18. The receiver-driven video stream of claim 17, wherein the original coded video stream, the different coded video stream and the switching stream are selected from at least three coded video streams and at least four switching streams.

19. The receiver-driven video stream of claim 17, wherein the original coded video stream, the different coded video stream and the switching stream are selected from at least three coded video streams and at least six switching streams.

20. The receiver-driven video stream of claim 17, wherein streaming of the original coded video stream, the different coded video stream and the switching stream is based at least in part on one or more hinting tracks each corresponding to one of a plurality of coded video streams coded at different bit rates and one or more hinting tracks each corresponding to one of a plurality of switching streams for switching from a coded video stream at a first bit rate to a coded video stream at a second bit rate.
